(19) United States
(12) Patent Application Publication
(10) Pub. No.: US 2022/0084458 A1
(43) Pub. Date: Mar. 17, 2022

(54) DISPLAY CONTROL DEVICE AND NON-TRANSITORY TANGIBLE COMPUTER READABLE STORAGE MEDIUM

(71) Applicant: DENSO CORPORATION, Kariya-city (JP)

(72) Inventors: Yasushi SAKUMA, Kariya-city (JP); Takeshi HATOH, Kariya-city (JP); Daisuke TAKEMORI, Kariya-city (JP); Kazuki KOJIMA, Kariya-city (JP)

(21) Appl. No.: 17/456,310

(22) Filed: Nov. 23, 2021

Related U.S. Application Data
(63) Continuation of application No. PCT/JP2020/012341, filed on Mar. 19, 2020.

(30) Foreign Application Priority Data
May 31, 2019 (JP) 2019-102276

(51) Int. Cl. G09G 3/20; G06T 11/00; G01C 21/36

(52) U.S. Cl. CPC G09G 3/2096; G06T 11/00; G09G 2340/12; G09G 2380/10; G01C 21/365

(57) ABSTRACT

A display control device, for a vehicle, controls a display of a virtual image by a head-up display. The display control device generates a guidance display object that guides a traveling route for the vehicle. The display control device recognizes a remaining distance from the vehicle to a guide point at which a route guidance by the guidance display object is generated.

### CROSS REFERENCE TO RELATED APPLICATIONS

The present application is a continuation application of International Patent Application No. PCT/JP2020/012341 filed on Mar. 19, 2020, which designated the U.S. and claims the benefit of priority from Japanese Patent Application No. 2019-102276 filed on May 31, 2019. The entire disclosures of all of the above applications are incorporated herein by reference.

### TECHNICAL FIELD

The disclosure herein relates to a display control device and non-transitory tangible computer readable storage medium for controlling a display of a virtual image.

### BACKGROUND

For example, a head-up display device configured to display an instruction image superimposed on a road surface that is a target to be instructed such as a branch point for turning left or right has been proposed. In addition, the head-up display device displays a guide image arranged above the instruction image. The instruction image is highlighted due to approach to the branch point to be instructed, while visibility of the guide image is reduced.

### SUMMARY

The present disclosure provides a display control device, for a vehicle, configured to control a display of a virtual image by a head-up display. The display control device generates a guidance display object that guides a traveling route for the vehicle. The display control device recognizes a remaining distance from the vehicle to a guide point at which a route guidance by the guidance display object is generated.

### BRIEF DESCRIPTION OF DRAWINGS

The features and advantages of the present disclosure will become more apparent from the following detailed description made with reference to the accompanying drawings. In the drawings:

FIG. 1 is a block diagram showing an overall image of an in-vehicle configuration related to a virtual image display system;

FIG. 2 is a diagram showing an example of a display transition from a non-superimposed image to a superimposed virtual image or to a plurality of superimposed virtual images in a process in which route guidance accompanying an approach to an intersection is performed;

FIG. 3 is a chart representing a concept of the route guidance using a list of a correspondence relationship between a remaining distance to a guide target point and notification information;

FIG. 4 is a diagram showing an example of a display transition from a non-superimposed image to a superimposed virtual image or to a plurality of superimposed virtual images in a process in which guidance accompanying an approach to a destination is performed;

FIG. 5 is a chart representing a concept of guidance to a destination using a list of a correspondence relationship between a remaining distance to a guide target point and notification information;

FIG. 6 is a diagram showing an example of display transition in a low accuracy state in which accuracy of map data related to route guidance is lower than a standard accuracy state shown in FIG. 2;

FIG. 7 is a diagram showing an example of display transition in a high accuracy state in which accuracy of map data related to route guidance is higher than the standard accuracy state shown in FIG. 2;

FIG. 8 is a diagram showing an example of a scene in which consecutive branches are encountered; and

FIG. 9 is a flow chart showing details of a display control process performed in a display control device.

### DETAILED DESCRIPTION

For example, in a virtual image display, not only a guide image but also a superimposed display of an instruction image are started even when remaining distance to a branch point to be instructed is long and the branch point is difficult to see. With the start of displaying such an instruction image, an occupant may have a task of forcibly recognizing the branch point that is still difficult to perceive in an actual scene. As a result, there is a difficulty that smooth operation when approaching the branch point may be hindered.

The present disclosure provides a display control device that realize a virtual image display capable of assisting an occupant so that a vehicle can drive smoothly.

An exemplary embodiment of the present disclosure provides a display control device, for a vehicle, controls a display of a virtual image by a head-up display. The display control device includes a display generation unit, a distance recognizing unit, a display control unit, and an area limiting unit. The display generation unit is configured to generate a guidance display object that guides a traveling route for the vehicle. The distance recognizing unit is configured to recognize a remaining distance from the vehicle to a guide point at which a route guidance by the guidance display object is generated. The display control unit is configured to (i) display, as the guidance display object, a non-superimposed virtual image that does not identify a superimposition target when the remaining distance is longer than a switching distance, and (ii) display, as the guidance display object, a superimposed virtual image superimposed on a specific superimposition target when the remaining distance is shorter than the switching distance. The area limiting unit is configured to define a display permission range that allows a display of the superimposed virtual image within an angle of view at which the virtual image is configured to be displayed according to an accuracy of map data used for recognizing the remaining distance.

An exemplary embodiment of the present disclosure provides a display control device, for a vehicle, configured to control a display of a virtual image by a head-up display. The display control device includes a display generation unit, a distance recognizing unit, a display control unit, and an area limiting unit. The display generation unit is configured to generate a guidance display object that guides a traveling route for the vehicle. The distance recognizing unit is configured to recognize a remaining distance from the vehicle to a guide point at which a route guidance by the guidance display object is generated. The display control unit is configured to (i) display, as the guidance display object, a non-superimposed virtual image that does not identify a superimposition target when the remaining distance is longer than a switching distance, and (ii) display, as the guidance display object, a superimposed virtual image superimposed on a specific superimposition target when the remaining distance is shorter than the switching distance. The area limiting unit is configured to define a display permission range that allows a display of the superimposed virtual image within an angle of view at which the virtual image is configured to be displayed according to an accuracy of map data used for recognizing the remaining distance.

Another exemplary embodiment of the present disclosure provides a display control device, for a vehicle, configured to control a display of a virtual image by a head-up display. The display control device includes a display generation unit, a distance recognizing unit, a display control unit, and an area limiting unit. The display generation unit is configured to generate a guidance display object that guides a traveling route for the vehicle. The distance recognizing unit is configured to recognize a remaining distance from the vehicle to a guide point at which a route guidance by the guidance display object is generated. The display control unit configured to (i) first display, as the guidance display object, a non-superimposed virtual image that does not identify a superimposition target when the remaining distance is longer than a switching distance, and (ii) display, as the guidance display object, a superimposed virtual image superimposed on a specific superimposition target when the remaining distance is shorter than the switching distance. When high accuracy map data used for the route guidance at the guide point is available, the display control unit first displays, as the guidance display object, the superimposed virtual image even when the remaining distance is longer than the switching distance.

Another exemplary embodiment of the present disclosure provides a non-transitory tangible computer readable storage medium that includes instructions executed by at least one processor of a display control device for a vehicle. The display control device is configured to control a display of a virtual image by a head-up display. The instructions includes generating a guidance display object that guides a traveling route for the vehicle; recognizing a remaining distance from the vehicle to a guide point at which a route guidance by the guidance display object is generated; displaying, as the guidance display object, a non-superimposed virtual image that does not identify a superimposition target when the remaining distance is longer than a switching distance; displaying, as the guidance display object, a superimposed virtual image superimposed on a specific superimposition target when the remaining distance is shorter than the switching distance; and defining a display permission range that allows a display of the superimposed virtual image within an angle of view at which the virtual image is configured to be displayed according to an accuracy of map data used for recognizing the remaining distance.

Another exemplary embodiment of the present disclosure provides a non-transitory tangible computer readable storage medium that includes instructions executed by at least one processor of a display control device for a vehicle. The display control device is configured to control a display of a virtual image by a head-up display. The instructions includes generating a guidance display object that guides a traveling route for the vehicle; recognizing a remaining distance from the vehicle to a guide point at which a route guidance by the guidance display object is generated; first displaying, as the guidance display object, a non-superimposed virtual image that does not identify a superimposition target when the remaining distance is longer than a switching distance; and displaying, as the guidance display object, a superimposed virtual image superimposed on a specific superimposition target when the remaining distance is shorter than the switching distance. When high accuracy map data used for the route guidance at the guide point is available, the displaying the superimposed virtual image includes first displaying, as the guidance display object, the superimposed virtual image even when the remaining distance is longer than the switching distance.

In the exemplary embodiment of the present disclosure, when the remaining distance to the guide point is longer than the switching distance, the non-superimposed virtual image is displayed. Thus, the guide point is not specified by the guidance display object. As a result, it is possible to prohibit the occurrence of a task that forcibly recognizes the guide point that is difficult to perceive. Then, when the remaining distance to the guide point becomes shorter than the switching distance, the superimposed display is displayed as the guidance display object. According to such a change in the guidance display object, the guidance display object can direct the occupant's attention to the superimposed object at the timing when the recognition of the superimposed object becomes easy. As a result, the virtual image display can assist the driver to drive smoothly.

A display control device 100 according to an embodiment of the present disclosure configures a virtual image display system 10 used in a vehicle A together with a head up display (hereinafter referred to as “HUD”) device 30 and the like. The virtual image display system 10 displays a virtual image Vi that can be visually recognized by an occupant (for example, a driver) of the vehicle A. The virtual image display system 10 presents various information related to the vehicle A to the driver using the virtual image Vi.

The display control device 100 can communicate with other in-vehicle components via the communication bus of the in-vehicle network. For example, a navigation information providing unit 21, an ADAS information providing unit 22, a vehicle information providing unit 27, a driver information providing unit 28, an in-vehicle device 40, and the like are directly or indirectly electrically connected to the communication bus.

The navigation information providing unit 21 and the ADAS information providing unit 22 provide route guidance information related to a route guidance to the display control device 100. The navigation information providing unit 21 includes at least a navigation device mounted on the vehicle A. The navigation information providing unit 21 includes a map database that stores a large amount of map data (hereinafter referred to as “navigation map data”) used for the route guidance, a Global Navigation Satellite System (GNSS) receiver, and an external communication device. The navigation information providing unit 21 outputs, as the route guidance information, the navigation map data including route information to the destination set by the driver, a current position and direction of the subject vehicle, coordinates and shape information of an intersection that provides a route guidance, and the like. The route guidance information further includes congestion information indicating a degree of road congestion, type information indicating a road type, and the like.

The navigation information providing unit 21 may have a configuration capable of communicating with a mobile terminal capable of executing the navigation application software. The navigation information providing unit 21 having such a configuration provides the navigation map data and the route information acquired by communication with a mobile terminal to the display control device 100 as the route guidance information.

The ADAS information providing unit 22 includes a locator 23, an external sensor 24, a drive assist control system 25, and a high accurate map database (map DB) 26. The locator 23 generates high accurate positioning information indicating the lane in which the vehicle A is traveling using the composite positioning way in which the positioning signal received by the GNSS receiver is combined with the measurement information and the accurate map information of the inertial sensor and the external sensor 24.

The external sensor 24 is configured to include a front camera, millimeter wave and quasi-millimeter wave radar, a lidar, a sonar, and the like. The external sensor 24 detects a stationary object and a moving object in real time around the vehicle A, particularly within the front area of the vehicle A. For example, the external sensor 24 detects a road sign and a traffic light as a stationary object and a pedestrian and a cyclist as a moving object and the like.

The driving assistance control system 25 assists the driver's driving operation by using the high accuracy positioning information by the locator 23, the external sensing information by the external sensor 24, the high accuracy map data acquired from the high accuracy map database 26, and the like. The driving support control system 25 has a functional unit that realizes an automatic driving function such as Adaptive Cruise Control (ACC), lane trace control (LTC), and Lane Keeping Assist (LKA). In addition, the driving support control system 25 has a functional unit that realizes a collision avoidance function such as Forward collision warning (FCW) and Automatic emergency braking (AEB).

The high accuracy map database 26 stores the high accuracy map data as the map data with higher accuracy than the navigation map data provided by the navigation information providing unit 21. The high accuracy map data includes at least more detailed information about the information in the height (z) direction of the road than the navigation map data. The high accuracy map includes, in addition to information such as the center line of the roadway and a connection between roads, information such as three-dimensional positions and shapes of pedestrian crosswalks, stop lines, traffic signs, traffic lights, and the like. The high accuracy map database 26 suspends the provision of high accuracy map data in an area where the high accuracy map data is not yet developed.

The ADAS information providing unit 22 provides, as the route guidance information, the high accuracy position information, the drive assist control information from the drive assist control system 25, the high accuracy map information, and the like each described above to the display control device 100.

The subject vehicle information providing unit 27 is configured to include a plurality of in-vehicle sensors that measure the state of the vehicle A. The in-vehicle sensors include a vehicle speed sensor, an acceleration sensor, a gyro sensor, and the like. The vehicle information providing unit 27 provides information such as the current vehicle speed, acceleration, angular velocity, and vehicle attitude of the vehicle A as vehicle travelling information to the display control device 100.

The driver information providing unit 28 is configured to include at least a driver status monitor (Driver Status Monitor, hereinafter, “DSM”) mounted on the vehicle A, and has a near infrared light source, a near infrared camera, and an image analysis unit. The driver information providing unit 28 acquires information such as the eyepoint EP of the driver, the line-of-sight direction, and the degree of eye opening by analyzing the face image captured by the near-infrared camera. The driver information providing unit 28 provides the acquired sensing information of the driver to the display control device 100.

The in-vehicle device 40 is an electronic control unit mounted on the vehicle A, and is electrically connected to in-vehicle indicators such as a combination meter 41, a multi-information display (MID) 42, and a center information display (CID) 43. The in-vehicle device 40 integrally controls information presentation to the driver in response to a control request to each in-vehicle display device.

For example, on the display screen of the CID 43, a map image based on the navigation data, route information to the destination, and the like are displayed by the navigation device. The display screen of the CID 43 includes a touch panel 44 that can be touch-operated by a driver or the like. Based on the operation input to the touch panel 44, it is possible to set the destination and change the set value (for example, the scale of the map).

The HUD device 30 is electrically connected to the display control device 100, and acquires the video data generated by the display control device 100. The HUD device 30 includes a projector, a screen, a magnifying optical system, and the like. The HUD device 30 is accommodated in a housing space inside the instrument panel below the windshield WS.

The HUD device 30 projects the light of the display image formed as the virtual image Vi toward the projection range PA of the windshield WS. The light projected toward the windshield WS is reflected toward the driver's seat in the projection area PA and is perceived by the driver. The driver visually recognizes the display image in which the virtual image Vi is superimposed on the superimposition target in the front view which is viewed through the projection range PA.

In the HUD device 30, an angle of view VA is set. When a virtual range in the space where the virtual image Vi can be imaged by the HUD device 30 is defined as an imaging plane IS, the angle of view VA is defined as an angle defined based on a virtual line connecting the driver's eye point EP and an outer edge of the image plane IS. The angle of view VA is a range of angle within which the driver can visually recognize the virtual image Vi when viewed from the eye point EP. When viewed from the eye point EP, a front range that overlaps with the image plane IS is the range of the angle of view VA. In other words, the virtual image Vi can be superimposed only on the object within the range visible through the image plane IS.

In the HUD device 30, the angle of view VA is an area that overlaps with a limited part of the entire surface of the windshield WS when viewed from the eye point EP. In the HUD device 30, the horizontal angle of view in the horizontal direction is larger than the vertical angle of view in the vertical direction. As an example, the angle of view VA is, for example, about 10 to 12° in the horizontal direction and about 4° to 6° in the vertical direction.

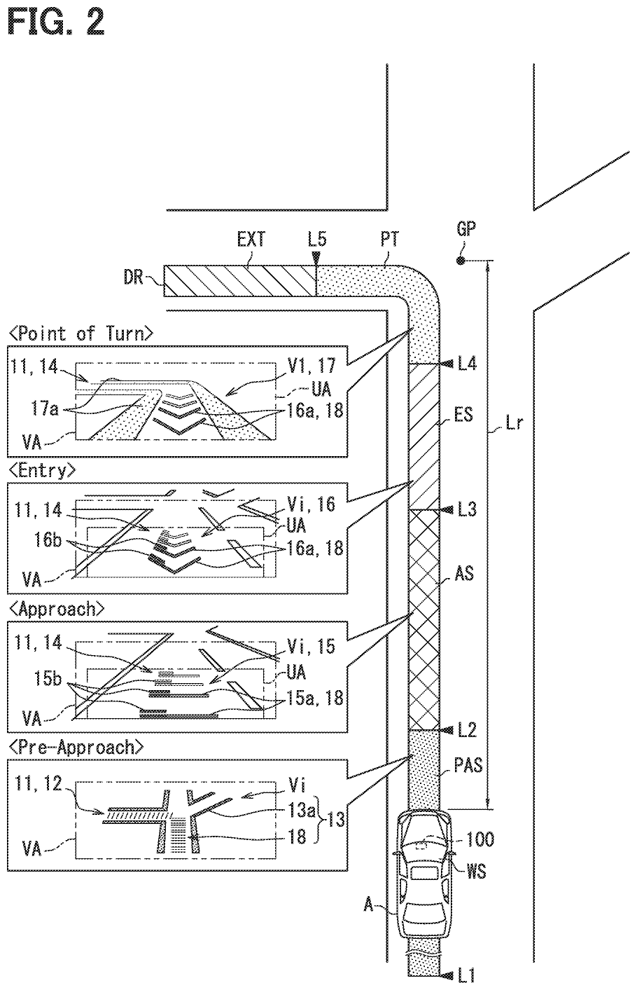

The HUD device 30 forms a virtual image Vi at a position relatively far forward from the windshield WS. Specifically, the HUD device 30 forms the virtual image Vi in a space of about 10 to 20 m in the front direction of the vehicle A from the eye point EP. The virtual image Vi has a superimposed virtual image 14 and a non-superimposed virtual image 12 (see FIG. 2).

The superimposed virtual image 14 is associated with a specific superimposition target visible through the projection range PA and the image plane IS, for example, a vehicle in front, a pedestrian, a road sign, a road surface, and the like. The superimposed virtual image 14 is superimposed on the superimposition target. The superimposed virtual image 14 moves together with the superimposition target so as to be relatively fixed to the superimposition target when viewed from the driver. That is, the relative positional relationship is continuously maintained among the driver's eye point EP, the superimposition target in the foreground, and the superimposed virtual image 14. The superimposed virtual image 14 presents information to the driver as a so-called Augmented Reality (hereinafter referred to as “AR”) display object. The shape of the superimposed virtual image 14 is continuously updated at a predetermined period according to the relative position and shape of the superimposition target. The superimposed virtual image 14 is displayed in a posture closer to horizontal than the non-superimposed virtual image 12, and has a display shape extended in the depth direction (traveling direction) as seen from the driver, for example.

On the other hand, the non-superimposed virtual image 12 is a non-AR display object excluding the superimposed virtual image 14 among the displayed objects superimposed on the foreground. Unlike the superimposed virtual image 14, the non-superimposed virtual image 12 is simply superimposed on the foreground without specifying the superimposition target. The display position of the non-superimposed virtual image 12 is not associated with a specific superimposition target. Therefore, the non-superimposed virtual image 12 is imaged at a fixed position in the projection range PA (imaging plane IS), and is displayed as if it is fixed to a vehicle configuration such as a windshield WS. The display shape of the non-superimposed virtual image 12 may be maintained substantially constant. The non-superimposed virtual image 12 may be accidentally superimposed on the superimposed virtual image 14 due to the positional relationship between the eye point EP and the superimposition target.

The display control device 100 is an electronic control unit that controls the display of the virtual image Vi via the HUD device 30. The control circuit of the display control device 100 is mainly configured by a computer having a processor 61, a RAM 62, a memory device 63, and an input/output interface. The processing unit 61 includes at least one arithmetic core, such as a central processing unit (CPU) or a graphics processing unit (GPU). The processor 61 may further include a field-programmable gate array (FPGA) and an IP core having other dedicated functions. The RAM 62 may include a video RAM for generating video. The processing unit 61 accesses the RAM 62 to execute various processes for providing the functions of respective functional blocks.

Various programs to be executed by the processor 61 are stored in the memory device 63. In the memory device 63, a plurality of application programs (50a to 50e) for generating contents displayed as a virtual image, an information presentation management program for integrally controlling virtual image display of contents, and the like are stored as a display control program. The display control device 100 has a common information generation block 71 and an integrated display control block 73 as functional blocks based on the information presentation management program.

The common information generation block 71 is information commonly used in the superimposed display applications (SDApp) 50a to 50e and the integrated display control block 73, and acquires information necessary for determining the design of the virtual image Vi from the communication bus. In addition to the route guidance information, the common information generation block 71 can acquire driving support control information, subject vehicle motion information, driver sensing information, and the like from the communication bus.

Based on the information provided by the common information generation block 71, the superimposed display applications 50a to 50e perform the generation of the content related to the ADAS function and the cockpit function and the setting of the display flag thereof. Each of the superimposed display applications 50a to 50e is associated with the ACC function, the LKA function and the FCW function of the driving support control system 25, and the navigation device and the like. Each of the superimposed display applications 50a to 50e individually determines the content to be displayed as a virtual image according to the provided information, and issues a display request to the integrated display control block 73.

The integrated display control block 73 uses the information provided by the common information generation block 71 to generate video data of the virtual image Vi based on the display request from the respective superimposed display applications 50a to 50e. The integrated display control block 73 has a display adjustment unit 74, a superimposed display correction unit 75, and a drawing output unit 76.

The display adjustment unit 74 is a functional unit that adjusts the content to be displayed as a virtual image Vi. The display adjustment unit 74 selects the content with high priority from the acquired display request, and sets the content as a virtual image display target. With such setting, for example, the content that notifies the information with the high priority (or the high urgent level) related to the FCW function is virtually always displayed and is displayed promptly.

The superimposition display correction unit 75 generates correction information for correctly superimposing the superimposed virtual image 14 on the superimposition target based on the information acquired by the common information generation block 71. The correction information is information for adjusting the imaging position of the virtual image Vi on a virtual line that three-dimensionally connects the superimposition target and the eye point EP. The superimposition display correction unit 75 sequentially generates the correction information in view of considering the relative position of the superimposition target, the position of the eyepoint EP, the vehicle attitude, and the like.

The drawing output unit 76 generates video data by a process of drawing the original image of the content selected by the display adjustment unit 74. The rendering output unit 76 adjusts the drawing position and drawing shape of the original image based on the correction information by the superimposition display correction unit 75, in each frame of the video data. The drawing output unit 76 outputs the generated video data to the HUD device 30 in a video format defined in advance.

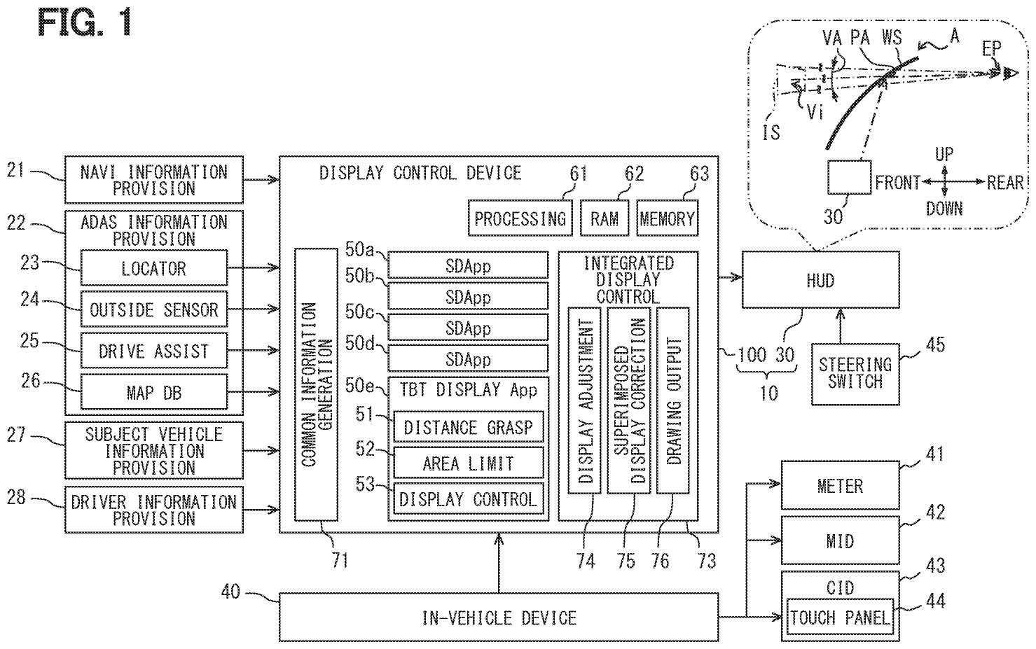

In the display control device 100 shown in FIGS. 1 and 2, one of the superimposed display applications 50a to 50e is a TBT display application 50e. The TBT display application 50e controls the display of the guidance display object 11 that guides the traveling route DR of the vehicle A to the driver based on the route information. The display of the guidance display object 11 starts with the approach to the guidance point GP such as, an intersection and a branch, and a destination and a temporary stop, and terminates when the guide intersection or the like passes or arrives at the destination or the like. Based on the display request from the TBT display application 50e, the integrated display control block 73 generates video data including the guidance display object 11. The TBT display application 50e includes a distance recognizing unit 51, an area limiting unit 52, and a display control unit 53 as sub-functional blocks for controlling the display of the guidance display object 11.

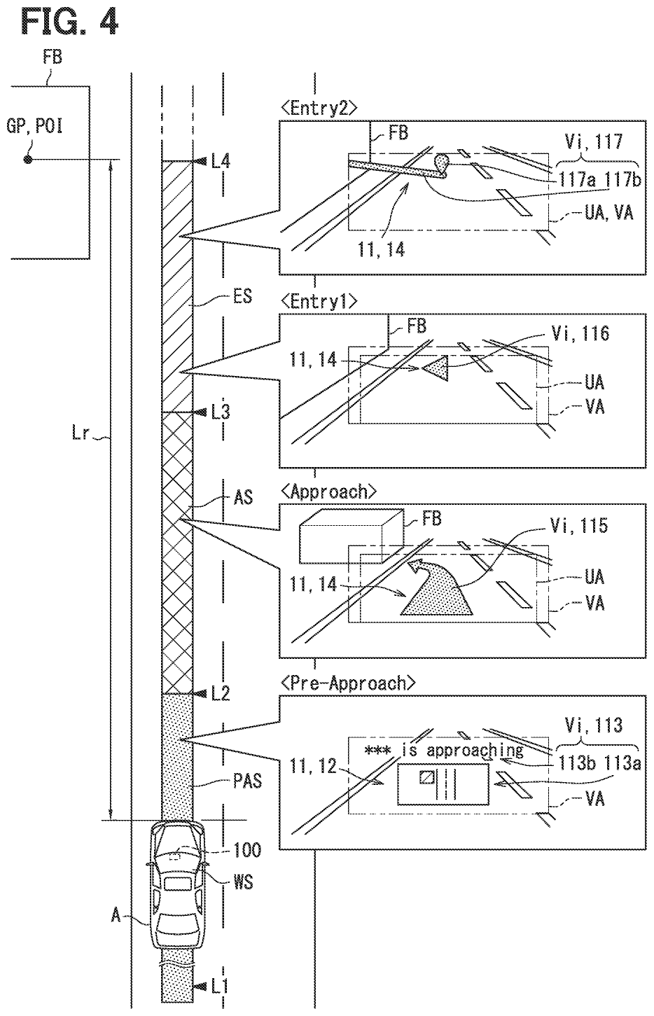

The distance recognizing unit 51 determines the type of the guidance point GP to be the latest guidance target based on the route guidance information. The distance recognizing unit 51 further recognizes the information necessary for the route guidance from the route guidance information according to the type of the determined guidance point GP. Specifically, when the guidance target is an intersection, the distance recognizing unit 51 recognizes the current position and direction of the vehicle A, the coordinates of the guidance intersection, the shape of the guidance intersection that becomes the guidance point GP, the exit direction in the guidance intersection based on the traveling route DR, the remaining distance Lr from the vehicle A to the guide intersection, and the like. When the guidance target is a destination, the distance recognizing unit 51 recognizes the current position and direction of the vehicle A, the coordinates of the destination set in the navigation map data, the road shape around the destination, the remaining distance Lr from the vehicle A to the guide intersection (see FIG. 4), and the like. When there is high accuracy position information by the common information generation block 71, the distance recognizing unit 51 can recognize the current position, direction, and the like of the vehicle A by using the high accuracy position information.

The area limiting unit 52 limits the display permission range UA that allows the display of the superimposed virtual image 14 to a part of the angle of view VA (imaging plane IS) that is a region in which the virtual image Vi can be visually displayed. The area limiting unit 52 defines the display permission range UA in a lower part of the image plane IS so that the center of the display permission range UA is below the center of the angle of view VA. The display permission range UA is defined to include the lower edge of the angle of view VA. When the driver sees the angle of view VA from the eye point EP, the driver visually recognizes the road surface in front of the vehicle A through the display permission range UA. Therefore, the display permission range UA is a range in which the overlap deviation due to a road shape such as a slope and a curve is likely to be minimized.

The area limiting unit 52 can scale up or down the display permission range UA and, for example, expands the display permission range UA upward. The display permission range UA may be expanded to, for example, the entire angle of view VA. As an example, the area limiting unit 52 moves the upper edge of the display permission range UA upward and largely defines the display permission range UA as the remaining distance Lr to the guide intersection is shorter.

The area limiting unit 52 switches the method of defining the display permission range UA for the front range of the vehicle A according to the accuracy of the map data which is the basis of the route guidance information. The area limiting unit 52 determines whether or not there is high accuracy map data that can be used for the route guidance at the guidance point GP. When the area limiting unit 52 determines that there is high accuracy map data, the area limiting unit 52 further determines the accuracy of the high accuracy map data.

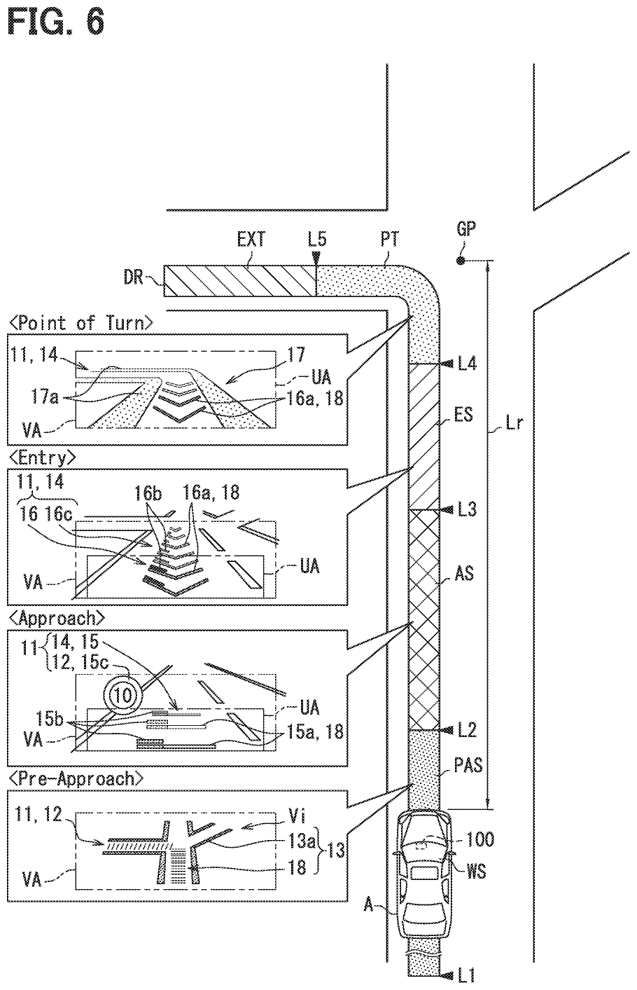

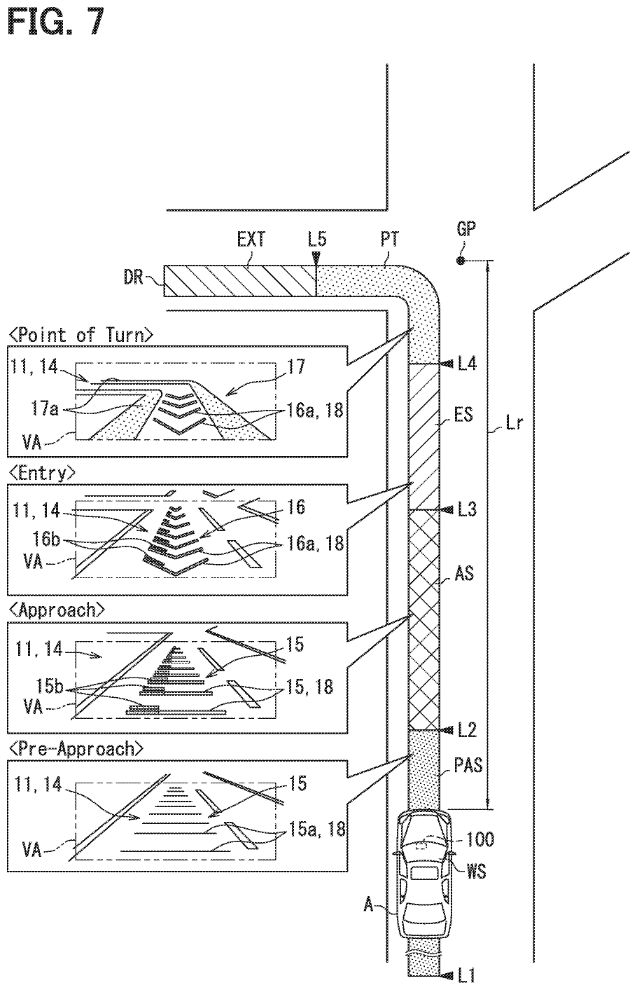

When there is high accuracy map data having sufficient accuracy, the area limiting unit 52 determines that it is in a high accuracy state, and cancels the setting of the display permission range UA. In this case, the superimposed virtual image 14 can be displayed over the entire range of the angle of view VA (see FIG. 7). On the other hand, when the high accuracy map data exists but its accuracy is not sufficient, the area limiting unit 52 determines that it is in a standard accuracy state and sets the display permission range UA. After that, the size, shape, position, and the like of the display permission range UA are changed according to the remaining distance Lr (see FIGS. 2 and 4). Further, when there is only navigation map data, the area limiting unit 52 determines that the accuracy state is low, and sets the display permission range UA narrower than the standard accuracy state. In this case, the easy-to-understand guidance regarding the guidance point GP is ensured by devising the virtual image display in the range excluding the display permission range UA in the angle of view VA (see FIG. 6).

The area limiting unit 52 changes the display permission range UA based on the recognition information about the front of the vehicle A. The recognition information includes detection information of the vehicle in front based on the external sensing information, road shape information such as a slope and a curve based on the external sensing information and high accuracy map information, and the like. Further, the area limiting unit 52 expands the display permission range UA upward when a vehicle in front that may overlap with the virtual image Vi is not detected. In addition, the area limiting unit 52 may expand the display permission range UA upward and laterally according to the road shape in front of the vehicle, specifically, the slope and the curve.

The area limiting unit 52 can change the setting of the display permission range UA based on the operation input by the occupant such as the driver. Such an operation is input to an operation unit such as a touch panel 44 or a steering switch 45. The driver can set the initial size of the display permission range UA before expansion, whether or not to permit expansion of the display permission range UA, and the like by inputting to the operation unit. For example, the area limiting unit 52 may switch whether or not to set the display permission range UA based on the presence or absence of high accuracy map data based on the setting by the driver.

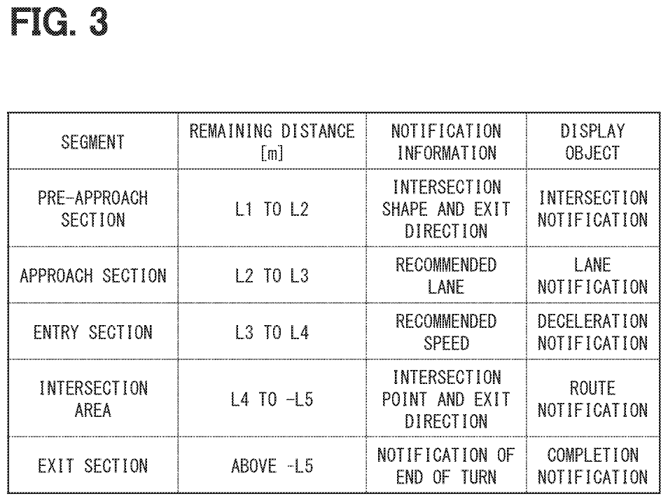

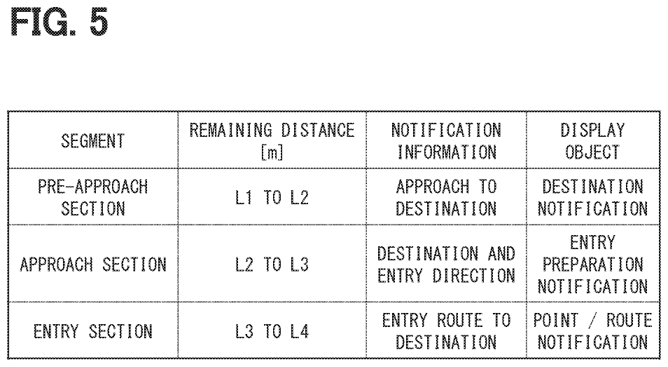

The display control unit 53 switches the display object to be displayed as a virtual image according to the remaining distance Lr from the vehicle A to the guide point GP, and suggests to the driver the driving operation corresponding to the remaining distance Lr. When guiding an intersection or the like, the display control unit 53 sets each threshold distance such as a display start distance L1, a switching distance L2, an approach distance L3, an entry distance L4, and an exit distance L5 as threshold values to be compared with the remaining distance Lr (See FIG. 3). Further, when guiding the destination or the like, the display control unit 53 sets the display start distance L1, the switching distance L2, the approach distance L3, the entry distance L4, and the like as threshold values to be compared with the remaining distance Lr (see FIG. 5). The display control unit 53 changes the notification information to be notified to the driver by dynamically switching the virtual image display based on the comparison between the remaining distance Lr and each threshold distance (L1 to L5 or L1 to L4), and suggests the driver for the necessary driving operation at the necessary timing.

The display control unit 53 switches the guidance display object 11 from the non-superimposed virtual image 12 to the superimposed virtual image 14 according to the remaining distance Lr to the guide point GP. Specifically, the display control unit 53 displays the non-superimposed virtual image 12 as the guidance display object 11 when the remaining distance Lr is longer than the switching distance L2. Then, when the remaining distance Lr from the vehicle A to the guide point GP becomes shorter than the switching distance L2, the display control unit 53 displays the superimposed virtual image 14 as the guidance display object 11 instead of the non-superimposed virtual image 12. The superimposed virtual image 14 is displayed at substantially the same position as the non-superimposed virtual image 12 in order to indicate that it is a guidance display object 11 related to the non-superimposed virtual image 12. That is, at least a part of the display range of the superimposed virtual image 14 seen from the eye point EP overlaps with the display range of the non-superimposed virtual image 12.

The display control unit 53 changes the superimposed virtual image 14 based on the remaining distance Lr to the guide point GP. When performing the route guidance at an intersection or the like, the superimposed virtual image 14 displayed as the guidance display object 11 includes a lane notification virtual image 15, a deceleration notification virtual image 16, a route notification virtual image 17, a completion notification virtual image, and the like. In this case, the display control unit 53 switches each superimposed virtual image 14 in order based on the comparison between the remaining distance Lr and each threshold distance (L2 to L5). Similarly, when guiding a destination or the like, the superimposed virtual image 14 displayed as the guidance display object 11 includes an approach preparation notification virtual image 115, a point notification virtual image 116, a route notification virtual image 117, and the like. In this case, the display control unit 53 switches each superimposed virtual image 14 in order based on the comparison between the remaining distance Lr and each threshold distance (L2 and L3) (see FIG. 4).

In order to adjust the timing of information presentation to the driver, the display control unit 53 can change each threshold distance (L1 to L5) for changing the non-superimposed virtual image 12 and the superimposed virtual image 14 based on the driving environment information of the road serving as the traveling route DR and the operation input by the occupant such as the driver. By changing each threshold distance, the timing of starting the display of the non-superimposed virtual image 12 and the superimposed virtual image 14 and the timing of the state transition for changing the superimposed virtual image 14 are adjusted.

The display control unit 53 uses, for example, the road type information and the congestion information included in the route guidance information as the traveling environment information. Based on the type information, the display control unit 53 sets each threshold distance longer when the subject vehicle travels on a road with a fast traffic flow such as a national road than when the subject vehicle travels on a road with a slow traffic flow. Further, the display control unit 53 sets each threshold distance (L1 to L5) with reference to time when it is estimated that the road is congested based on the congestion information. Specifically, the display control unit 53 sets each threshold distance (L1 to L5) before a specific second arriving at the guide intersection based on the expected arrival time to the guide intersection.

Next, the details of the state transition of the guidance display object 11 in a plurality of route guidance scenes will be described in order with reference to FIG. 1 based on FIGS. 2 to 7. FIGS. 2 and 3 show the details of the state transition of the guide display 11 with the passage of the guide intersection, which is one guide point GP. The TBT display application 50e once displays the intersection notification virtual image 13 which is the non-superimposed virtual image 12 as the guidance display object 11. Thereafter, as described above, the TBT display application 50e displays the lane notification virtual image 15, the deceleration notification virtual image 16, notification virtual image 17, and the completion notification virtual image which are the superimposed virtual images 14.

Here, a plurality of path line portions 18 are drawn as common display elements on each virtual image Vi displayed as the guidance display object 11. Each path line portion 18 has a shape extending linearly along the width direction of the road surface, and is arranged along the road surface serving as the traveling path DR while being spaced apart from each other. Further, in the path line portion 18 included in the superimposed virtual image 14 such as the lane notification virtual image 15, the deceleration notification virtual image 16, and the route notification virtual image 17, or the like, drawing shape and drawing position based on a layout simulation using a 3D model are defined. More specifically, each path line portion 18 in the superimposed virtual image 14 is drawn based on a 3D model in which linear objects or bent linear objects of the same length are arranged at equal intervals on the traveling path DR. Therefore, according to the perspective method, the length of each path line portion 18 gradually becomes shorter from the lower side to the upper side, in other words, from the front side to the back side in appearance. In addition, the interval between the adjacent two of the path line portions 18 also gradually narrows from the front side to the back side. Further, by imparting an aerial perspective visual effect, each path line portion 18 is gradually reduced in attractiveness and becomes inconspicuous from the front side to the back side. Specifically, in order to reduce the attractiveness and make it inconspicuous, the path line portion 18 on the back side is adjusted so as to have a lower brightness to increase the apparent transmittance, a lower brightness of the display color, and a smaller display size.

The intersection notification virtual image 13 is a guidance display object 11 that notifies the approach to the guide intersection as the guide point GP. The intersection notification virtual image 13 is displayed such that the intersection shape image 13a showing the overall shape of the guide intersection is combined with a large number of path line portions 18 showing the exit direction from the guide intersection. The intersection notification virtual image 13 is a non-AR display object, and is displayed as a virtual image in a size that spreads over substantially the entire angle of view VA without being superimposed on a specific superimposition target.

The intersection notification virtual image 13 is displayed as a virtual image in a pre-approach section PAS defined in front of the guide point GP. The pre-approach section PAS is a section in which the remaining distance Lr to the guide point GP is from a display start distance L1 to a switching distance L2. The display start distance L1 is set, for example, at a point where the remaining distance Lr is 700 m. The switching distance L2 is set, for example, at a point where the remaining distance Lr is 300 m. The display of the intersection notification virtual image 13 starts at the timing when the remaining distance Lr becomes the display start distance L1, and ends at the timing when a specific time (several seconds) elapses from the display start. The reason why the display of the intersection notification virtual image 13 is not continued until the switching distance L2 is to prevent the entire angle of view VA from being covered by the intersection notification virtual image 13 for a long time.

The TBT display application 50e indicates the moving direction of the vehicle A at the guide intersection by performing an animation in which a plurality of route line portions 18 arranged along the traveling route DR are displayed in order from the front (bottom) side. The TBT display application 50e ends the display of the intersection notification virtual image 13 at the timing when a specific time elapses from the start of the display. The specific time is predetermined so that the animation of the path line portions 18 are displayed once or a plurality of times. The number of repetitions of such an animation can be changed, for example, based on the driver's sensing information by DSM. As an example, when a driver's inattentiveness that takes his eyes off the angle of view VA is detected, the TBT display application 50e can increase the number of times the animation is repeated by extending the specific time.

The lane notification virtual image 15 is a guidance display 11 that notifies the recommended lane in which the driver should move the vehicle A by the time the driver reaches the guidance intersection. The lane notification virtual image 15 is displayed in the display permission range UA. The lane notification virtual image 15 includes a road surface image 15a and a direction notification image 15b. The road surface image 15a is superimposed on the road surface in front of the vehicle A. As described above, the road surface image 15a is represented by a plurality of path line portions 18 extending linearly along the width direction of the road. When the front of the guide intersection has a curved shape, the road surface image 15a may be displayed by a plurality of route line portions 18 arranged along the curved road surface.

The direction notification image 15b is displayed adjacent to the upper side or the lower side of each path line portion 18. The direction notification image 15b has a length shorter than that of the path line portion 18 and extends linearly along the path line portion 18. Each direction notification image 15b may be a part (end) of each path line portion 18. An adjacent portion of the route line portion 18 adjacent to the lane notification virtual image 15 is displayed in substantially the same display color as the direction notification image 15b. On the other hand, the display color of a non-adjacent portion of the path line portion 18 that is not adjacent to the lane notification virtual image 15 is a display color different from that of the direction notification image 15b and the adjacent portion.

The left or right relative positions of the direction notification image 15b with respect to the road surface image 15a (path line portion 18) is a direction for making a right or left turn at a guidance intersection, and indicates the left or right direction for moving the vehicle A to the guidance intersection. That is, when it is necessary to move the vehicle A to the rightmost lane by the guide intersection, the direction notification image 15b is displayed at the right end of the road surface image 15a. When it is necessary to move the vehicle A to the leftmost lane by the guide intersection, the direction notification image 15b is displayed at the left end of the road surface image 15a.

The lane notification virtual image 15 is displayed in the approach section AS. The approach section AS is defined along the travel path DR on the side closer to the guide point GP than the pre-approach section PAS. The approach section AS is a section in which the remaining distance Lr to the guide point GP is from the switching distance L2 to the approach distance L3. The approach distance L3 is set at a point where the remaining distance Lr is 100 m, as an example. The display of the lane notification virtual image 15 is started at the timing when the remaining distance Lr becomes the switching distance L2, and continues until the remaining distance Lr becomes the approach distance L3.

The deceleration notification virtual image 16 is a guidance display 11 that notifies the recommended speed when entering the guidance intersection and urges the driver to decelerate. The deceleration notification virtual image 16 is displayed in the display permission range UA like the lane notification virtual image 15, and includes a road surface image 16a and a direction notification image 16b. Unlike the road surface image 15a, the road surface image 16a has a plurality of path line portions 18 having a flat and horizontally long V-shape. The road surface image 16a composed of the downwardly convex (or upwardly convex) path line portions 18 is superimposed on the front road surface of the vehicle A. Due to the shape change from the road surface image 15a to the road surface image 16a, the deceleration notification virtual image 16 allows the driver to intuitively recognize the sense of distance to the guide intersection. The direction notification image 16b, in combination with the road surface image 16a, continuously indicates the left-right direction in which the vehicle A is moved to the guide point GP.

The deceleration notification virtual image 16 is changed to a mode that calls attention to the high traveling speed when it is determined that the approaching speed to the guide intersection is too high based on the traveling speed of the vehicle A. For example, the TBT display application 50e sets a speed threshold value corresponding to the remaining distance Lr. When the traveling speed of the vehicle A exceeds the speed threshold value, the display color of the deceleration notification virtual image 16 is changed to, for example, red or amber.

The deceleration notification virtual image 16 is displayed in the entry section ES. The entry section ES is defined along the travel path DR on the side closer to the guide point GP than the approach section AS. The entry section ES is a section in which the remaining distance Lr to the guide point GP is from the approach distance L3 to the entry distance L4. The entry distance L4 is set at a point where the remaining distance Lr is 30 m, as an example. The display of the deceleration notification virtual image 16 is started at the timing when the remaining distance Lr becomes the approach distance L3, and continues until the remaining distance Lr becomes the entry distance L4.

The route notification virtual image 17 is a guidance display 11 that notifies the driver of the position of the guidance intersection for turning left or right and the exit notification from the guidance intersection. Due to the upward extension of the display permission range UA, the route notification virtual image 17 is displayed using almost the entire projection range PA. The route notification virtual image 17 includes the road surface image 16a continuously displayed from the deceleration notification virtual image 16 and a route image 17a. The route image 17a is arranged on both sides of the road surface image 16a and extends in a band shape along the traveling route DR. The route notification virtual image 17 is superimposed on the front road surface including the guide point GP, and the curve of the route image 17a according to the travel route DR indicates the exit direction from the guide intersection.

The route notification virtual image 17 is displayed in the intersection range PT. The intersection range PT is defined to include the guide point GP. The intersection range PT is an area where the remaining distance Lr to the guide point GP is from the entry distance L4 to the exit distance L5. As an example, the exit distance L5 is set at a point where the remaining distance Lr is −30 m, that is, a point 30 m in the exit direction from the guide point GP. The display of the route notification virtual image 17 is started at the timing when the remaining distance Lr becomes the entry distance L4, and continues until the remaining distance Lr becomes the exit distance L5.

The completion notification virtual image is a guidance display 11 that notifies the end of a right or left turn at the guidance intersection. The completion notification virtual image includes a road surface image superimposed on the front road surface. By implementing an animation in which a plurality of route line portions 18 displayed as road surface images are displayed in order from the front (bottom) side, the completion notification virtual image notifies the driver that the right or left turn has been completed and prompt the driver to start the normal traveling along the road. The completion notification virtual image is displayed in the exit section EXT. The exit section EXT is defined along the travel path DR on the side farther from the guide point GP than the intersection range PT. The display of the completion notification virtual image is displayed at the timing when the remaining distance Lr becomes the exit distance L5, and ends at the timing when the animation is repeated a predetermined number of times.

FIGS. 4 and 5 to be described next show the details of the state transition of the guide display 11 with the arrival at a destination which is the guide point GP. The TBT display application 50e once displays the destination notification virtual image 113, which is the non-superimposed virtual image 12, as the guidance display object 11. Thereafter, as described above, the TBT display application 50e displays the approach preparation notification virtual image 115, the point notification virtual image 116, and the route notification virtual image 117, which are the superimposed virtual images 14, in order.

The destination notification virtual image 113 is a guidance display object 11 that notifies the approach to the destination (or waypoint) that is the guidance point GP. The destination notification virtual image 113 is displayed as a virtual image in a pre-approach section PAS defined in front of the guide point GP. In the pre-approach section PAS, a destination facility building FB is outside the angle of view VA. The destination notification virtual image 113 is displayed such that a destination bird's-eye view image 113a showing the left and right positions of the destination with respect to the traveling road is combined with a message image 113b notifying the arrival at the destination. The destination notification virtual image 113 is a non-AR display object, and is displayed as a virtual image slightly below the center of the angle of view VA without being superimposed on a specific superimposition target. The display of the destination notification virtual image 113 may be terminated after a specific time (several seconds) from the start of the display, or may be continued until the remaining distance Lr becomes the switching distance L2.

The approach preparation notification virtual image 115 is a guide display 11 that notifies the position in the foreground of the facility building FB or the like as the destination, the approach direction to the destination, and the like. The approach preparation notification virtual image 115 is displayed in the approach section AS. The switching distance L2 for switching from the pre-approach section PAS to the approach section AS is set to a distance such that a part of the facility building FB is within the angle of view VA.

The approach preparation notification virtual image 115 is displayed in the display permission range UA. The approach preparation notification virtual image 115 is an arrow-shaped display object superimposed on the road surface in front of the vehicle A. The approach preparation notification virtual image 115 points in the direction of the destination with respect to the traveling road by the iron portion on the back side in the traveling direction. The approach preparation notification virtual image 115 suggests the future behavior of the subject vehicle when entering the destination. The display of the approach preparation notification virtual image 115 is continued until the remaining distance Lr becomes the approach distance L3.

The point notification virtual image 116 and the route notification virtual image 117 are guidance display objects 11 for notifying the facility building FB as the destination or the route for entering the facility building FB. The point notification virtual image 116 and the route notification virtual image 117 are displayed in order in the period of traveling in the entry section ES. The point notification virtual image 116 and the route notification virtual image 117 are displayed in the display permission range UA and are superimposed on the road surface in the foreground.

The point notification virtual image 116 is a display object having a triangular shape, and the superimposed position and the display posture are defined based on the registered coordinates (Point Of Interest, POI) of the destination in the navigation map data. The point notification virtual image 116 is superimposed in the center of the traveling road in the foreground. The superimposed position of the point notification virtual image 116 in the front-rear direction is defined in a position that substantially coincides with the registered coordinates of the destination (hereinafter, “guidance end position”), or slightly in front (subject vehicle) side of the guidance end position. The display posture of the point notification virtual image 116 in the yaw direction is defined to point to the registered coordinates of the destination. The registered coordinates may depend on the navigation map data. The registered coordinates may be, for example, the center of the facility building FB, the center of the destination area including the facility building FB, the entrance and exit of the destination facility, and the like.

The route notification virtual image 117 includes an end point image 117a and an entry route image 117b. The end point image 117a has, for example, a teardrop shape as the display object. The end point image 117a indicates the guidance end position on the traveling road. The approach route image 117b is visually displayed below the end point image 117a. The approach route image 117b extends in a strip shape from the guidance end position toward the registered coordinates. The approach route image 117b suggests an approach route from the traveling road to the destination. The approach route image 117b may be displayed as an animation that repeatedly extends from the guidance end position toward the registered coordinates.

The TBT display application 50e executes a display transition to the route notification virtual image 117 based on the lapse of a specific time from the start of the display of the point notification virtual image 116 in the entry section ES. The TBT display application 50e terminates the display of the route notification virtual image 117 at the timing when the vehicle A reaches the guidance end position or when the guidance end position is outside the angle of view VA.

FIG. 6, which will be described next, shows the details of the state transition of the guidance display object 11 when the accuracy of the map data used for route guidance is lower than that of the traveling scene shown in FIG. 2. Even in such a low accuracy state, the TBT display application 50e displays the intersection notification virtual image 13, the lane notification virtual image 15, the deceleration notification virtual image 16, and the route notification virtual image 17 including the path line portion 18 in order as common display elements. On the other hand, in the low accuracy state, the display permission range UA set in the approach section AS and the entry section ES is narrower than the standard accuracy state shown in FIG. 2. Hereinafter, the details of each display of the approach section AS and the entry section ES will be described in order.

The guidance display 11 displayed in the approach section AS includes a deceleration sign virtual image 15c in addition to the lane notification virtual image 15. The lane notification virtual image 15 is a superimposed virtual image 14 displayed within the display permission range UA and including the road surface image 15a and the direction notification image 15b. The lane notification virtual image 15 is more unclear in a vicinity of the upper edge of the display permission range UA than in a vicinity of the lower edge of the display permission range UA so that the display deviation with respect to the foreground is not noticeable.

The deceleration sign virtual image 15c is a non-superimposed virtual image 12. Most part of the deceleration sign virtual image 15c is displayed in the range of the angle of view VA excluding the display permission range UA. The deceleration sign virtual image 15c is arranged obliquely above the lane notification virtual image 15 so as not to overlap with the lane notification virtual image 15. The deceleration sign virtual image 15c is a display that prompts the driver to prepare for deceleration to a very low speed on the assumption of approaching the destination. The deceleration sign virtual image 15c is designed to imitate a sign indicating a very low speed limit.

The guidance display 11 displayed in the entry section ES includes an extended deceleration notification virtual image 16c in addition to the deceleration notification virtual image 16. The deceleration notification virtual image 16 is a superimposed virtual image 14 displayed within the display permission range UA, and includes a road surface image 16a and a direction notification image 16b. The deceleration notification virtual image 16 is also displayed less clearly as it is closer toward the upper edge of the display permission range UA.

The extended deceleration notification virtual image 16c is a superimposed virtual image 14 that is integrally displayed with the deceleration notification virtual image 16. The deceleration notification virtual image 16 mainly includes a road surface image 16a and a direction notification image 16b displayed outside the display permission range UA. The extended deceleration notification virtual image 16c is displayed more unclear than the deceleration notification virtual image 16 displayed in the vicinity of the upper edge of the display permission range UA. As a result, the deceleration notification virtual image 16 and the extended deceleration notification virtual image 16c integrally display the road surface image 16a and the direction notification image 16b in which the attractiveness is continuously lowered from the vicinity of the lower edge to the vicinity of the upper edge of the angle of view VA. Specifically, the road surface image 16a and the direction notification image 16b, which are visually recognized as the back side, are displayed in a display color having low brightness.

FIG. 7, which will be described next, shows the details of the state transition of the guidance display object 11 when the accuracy of the map data related to the route guidance is higher than that of the traveling scene shown in FIG. 2. Even in such a high accuracy state, the TBT display application 50e displays the intersection notification virtual image 13, the lane notification virtual image 15, the deceleration notification virtual image 16, and the route notification virtual image 17 including the path line portion 18 in order as common display elements. On the other hand, in the high accuracy state, the intersection notification virtual image 13 is provided as a superimposed virtual image 14. In addition, in the high accuracy state, the setting of the display permission range UA is omitted, so that the lane notification virtual image 15 and the deceleration notification virtual image 16 are different from the standard accuracy state. Hereinafter, the details of the intersection notification virtual image 13, the lane notification virtual image 15, and the deceleration notification virtual image 16 in the high accuracy state will be described in order.

The intersection notification virtual image 13 is a superimposed virtual image 14 including a road surface image 15a. The road surface image 15a is composed of a plurality of path line portions 18 extending linearly along the width direction of the road, as in the case of being displayed as the lane notification virtual image 15. The road surface image 15a is superimposed on the entire road surface in the foreground that overlaps the angle of view VA. The intersection notification virtual image 13 continues to be displayed until the remaining distance Lr becomes the switching distance L2.

The lane notification virtual image 15 is a superimposed virtual image 14 including a road surface image 15a and a direction notification image 15b, as in the case of the standard accuracy state. Similarly, the deceleration notification virtual image 16 is a superimposed virtual image 14 including the road surface image 16a and the direction notification image 16b, as in the case of the standard accuracy state. By canceling the setting of the display permission range UA (see FIG. 2), the road surface images 15a and 16a and the direction notification images 15b and 16b can be displayed in the range from the vicinity of the lower edge to the vicinity of the upper edge of the angle of view VA. As described above, since the display of the road surface image 15a is started in the intersection notification virtual image 13, a display change in which the direction notification image 15b is added occurs at the switching distance L2.

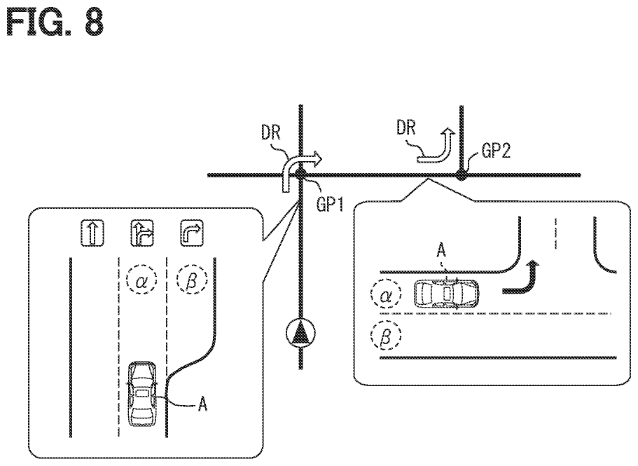

FIG. 8, which will be described next, shows information presentation when a continuous branch occurs in the traveling path DR. In this case, the TBT display application 50e can change the display of the lane notification virtual image 15 and the deceleration notification virtual image 16. The TBT display application 50e can acquire the recommended lane in which the vehicle A should travel from the navigation device as route guidance information. When the recommended lane has been acquired, the TBT display application 50e displays the notification virtual image 15 and the deceleration notification virtual image 16, which are different in a display manner from that of when turning left or right at the approach section AS and the entry section ES before the first guide point (branch point GP1).

Specifically, the TBT display application 50e displays, in order, the lane notification virtual image 15 in which the direction notification image 15b is arranged in the center of the road surface image 15a and the deceleration notification virtual image 16 in which the direction notification image 16b is arranged in the center of the road surface image 16a. Using the lane notification virtual image 15 and the deceleration notification virtual image 16 in such a way, the TBT display application 50e guides the user to the central lane (see α in FIG. 8) instead of the rightmost lane (see β in FIG. 8). When the driver has moved the vehicle A to the central lane according to the above display, the left turn at the second guide point (branch point GP2) can be smoothly performed.

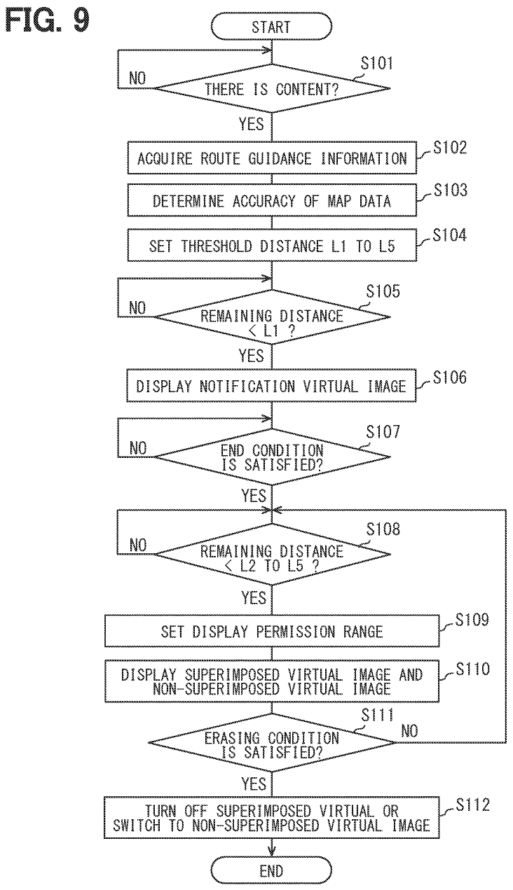

In order to realize the display of the guidance display object 11 described above, the entire display control process performed by the display control device 100 will be described in detail based on FIG. 9 and with reference to FIGS. 1 and 2 and the like. The display control process shown in FIG. 9 is triggered to start by the occurrence of a specific event such as completion of route setting in a navigation device or the like.

In S101, it is determined whether or not there is content to be displayed such as the guidance display object 11. When it is determined in S101 that there is the content to be displayed, the process proceeds to S102. On the other hand, when it is determined that there is no content to be displayed, the generation of the content such as the guidance display object 11 is waited for by repeating S101.

In S102, the route guidance information and the like are acquired, and the process proceeds to S103. The route guidance information acquired in S102 includes the recognition information, the road driving environment information, and the like. In S103, the accuracy of the map data in the range where the route guidance is performed is determined, and the process proceeds to S105. In S103, the state of the map data that can be acquired is set to one of the high accuracy state, a standard accuracy state, and a low accuracy state. In S104, among the route guidance information acquired in S102, each threshold distance (L1 to L5 or L4) is set based on the driving environment information of the road, and the process proceeds to S105. The number of threshold distances set in S104 is changed according to the type of guide point GP.

In S105, the remaining distance Lr is recognized, and it is determined whether the latest remaining distance Lr is less than the display start distance L1. When the remaining distance Lr is equal to or greater than the display start distance L1, the approach to the guide point GP is awaited by repeating S105. Then, when the remaining distance Lr becomes less than the display start distance L1, the process proceeds to S106.

In S106, the intersection notification virtual image 13 or the destination notification virtual image 113 or the like is displayed according to the type of the guidance point GP, and the process proceeds to S107. In S106, the notification virtual image of the guide point GP is switched between the non-superimposed virtual image 12 and the superimposed virtual image 14 based on the accuracy state of the map data determined in S103.

In S107, it is determined whether or not the display end condition of the intersection notification virtual image 13 or the destination notification virtual image 113 is satisfied. As described above, the elapsed time from the start of display, the number of times the animation is repeated, the arrival at the switching distance L2, or the like can be set as the display end condition. In S107, an appropriate end condition is set according to the type of the guide point GP, the accuracy state of the map data, and the like. Then, when it is determined in S107 that the display end condition is satisfied, the process proceeds to S108.

In S108, each threshold distance L2 to L5 (or L1 to L4) set in S104 is compared with the remaining distance Lr in order. In S108, the remaining distance Lr is recognized, and it is determined whether or not the latest remaining distance Lr is less than the switching distance L2. When the remaining distance Lr is equal to or more than the switching distance L2, the approach to the guide point GP is awaited by repeating S108. Then, at the timing when the remaining distance Lr becomes the switching distance L2, the process proceeds to S109.

In S109, the state of the road shape in front and the presence or absence of the vehicle in front based on the recognition information acquired in S102 and the display permission range UA corresponding to the accuracy state determined in S103 are set, and the process proceeds to S110. When it is determined in S102 that the map data that can be acquired is in the high accuracy state, the setting of the display permission range UA in S109 is omitted. On the other hand, when the display permission range UA is set in S109, the size of the display permission range UA is increased as the number of repetitions increases.

In S110, the display of the lane notification virtual image 15 or the approach preparation notification virtual image 115 is started, and the process proceeds to S111. By repeating the above S108 to S110, for example, when guiding the passage through the intersection, the guidance display object 11 is sequentially switched to the lane notification virtual image 15, the deceleration notification virtual image 16, the route notification virtual image 17, and the completion notification virtual image (see FIG. 2). Further, when guiding the arrival at the destination, the guidance display object 11 is sequentially switched to the approach preparation notification virtual image 115, the point notification virtual image 116, and the route notification virtual image 117 (see FIG. 4).

In S111, it is determined whether or not an erasing condition or a termination condition of the superimposed virtual image 14 is satisfied. The erasing condition and the termination condition are preset conditions. When guiding the intersection, for example, at least one of the conditions such as the fact that the distance from the guidance intersection by equal to or more than a predetermined distance, a predetermined time has passed from the start of display of the completion notification virtual image, and the vehicle A deviates from the traveling route DR is set as the erasing condition. On the other hand, when guiding the destination, for example, reaching the guidance end position is set as the termination condition. When it is determined in S111 that the erasing condition or the termination condition is not satisfied, the process returns to S108. As a result, the next threshold distance and the remaining distance Lr are compared. On the other hand, when it is determined in S111 that the erasing condition or the termination condition is satisfied, the process proceeds to S112. In S112, the display of the superimposed virtual image 14 is turned off, and the display control process is terminated. As a result, the guidance of one guidance point GP is completed. Then, when the route guidance is continued, the display of the non-superimposed virtual image 12 is started after the right or left turn is completed.

In the present embodiment described above, the non-superimposed virtual image 12 is displayed when the remaining distance Lr to the guide point GP is longer than the switching distance L2. Therefore, the guidance point GP is not specified by the guidance display object 11. As a result, it is possible to prohibit the occurrence of a task that forcibly recognizes the guide point GP that is located far away and is difficult to perceive.

Then, when the remaining distance Lr to the guide point GP becomes shorter than the switching distance L2, the superimposed virtual image 14 is displayed as the guidance display object 11. According to such a change in the virtual image display, the guidance display object 11 can direct the driver's attention to the superimposed object at the timing when the recognition of the superimposed object becomes easy. As a result, the virtual image display can assist the driver to drive smoothly.

In addition, the area limiting unit 52 of the present embodiment limits the display permission range UA that allows the display of the superimposed virtual image 14 to a part of the projection range PA in principle under a specific condition. According to such a limitation of the display range, the region of the angle of view of the HUD device 30 in which the superimposed virtual image 14 is likely to be displaced from the superimposed object is not used for AR display. Therefore, the driver's discomfort due to the superposition deviation of the superimposed virtual image 14 is less likely to occur.

Further, in the present embodiment, the display permission range UA is defined in the lower range of the projection range PA. Therefore, the superimposed virtual image 14 such as the lane notification virtual image 15 and the deceleration notification virtual image 16 is drawn at a position where there is a high possibility of overlapping with the front road surface regardless of the change of the attitude of vehicle A, the road shape, or the like. According to the limitation of the display range as described above, the superimposition deviation due to the road shape such as the slope and the curve, and the shielding of the preceding vehicle by the superimposed virtual image 14 are less likely to occur.

Further, in the present embodiment, in the intersection range PT having a short remaining distance Lr to the guide point GP, the area limiting unit 52 has a larger display permission range UA than the approach section AS and the entry section ES having a long remaining distance Lr. According to the adjustment control of the display permission range UA as described above, the display control unit 53 displays a large superimposed virtual image 14 when the region where the superimposition deviation is likely to occur is reduced. Therefore, the information presentation by the superimposed virtual image 14 becomes easier for the driver to understand.

In addition, in the present embodiment, the display permission range UA is changed based on the recognition information in front of the vehicle. Therefore, the display control unit 53 can appropriately display the superimposed virtual image 14 that is optimal for the state of the front range such as the road shape and the presence or absence of the vehicle in front. As a result, the information presentation by the superimposed virtual image 14 becomes easier for the driver to understand.

Further, in the present embodiment, the superimposed virtual image 14 is sequentially changed based on the remaining distance Lr to the guide point GP. According to the state transition of the superimposed virtual image 14, the driver can intuitively recognize the remaining distance Lr to the guide point GP even when the remaining distance Lr to the guide point GP is not directly displayed as a virtual image. With the above described configuration, since the driving behavior corresponding to the remaining distance Lr can be suggested to the driver, the driving operation by the driver such as lane change and deceleration is performed more smoothly.

Further, in the lane notification virtual image 15 of the present embodiment, the road surface image 15a is always displayed in a predetermined shape regardless of the road shape in front of the vehicle. Therefore, even when the number of lanes on the road on which the vehicle is traveling, the lane position on which the vehicle is traveling, the extension position of the lane, and the like are unknown, the TBT display application 50e can draw the lane notification virtual image 15. Therefore, even when it is difficult to acquire the high accuracy position information and the high accuracy map information, the guide display 11 can prompt the driver to move smoothly in the lane.

In addition, the direction notification image 15b can indicate the left-right direction in which the vehicle A should be moved, and thus the exit direction at the guide point GP, depending on the left-right relative position with respect to the road surface image 15a having the predetermined shape. In this way, the lane notification virtual image 15 can notify the driver of the desired driving behavior in an easy-to-understand manner by a simple display.

Further, in the present embodiment, the driver is urged to decelerate at an appropriate timing by displaying the deceleration notification virtual image 16 accompanying the approach to the entry section ES. In addition, the deceleration notification virtual image 16 can call attention to the high traveling speed at the time of approach. Based on the above configuration, the deceleration notification virtual image 16 can support the implementation of a smooth approach to the guide point GP.

Further, in the present embodiment, when the vehicle A enters the intersection range PT, the route notification virtual image 17 indicating the exit direction is displayed on the front road surface including the guide point GP. As described above, the display timing of the route notification virtual image 17 indicating the exit direction is delayed until the subject vehicle reaches the intersection range PT near the guide intersection. Thus, the exit direction indicated by the route notification virtual image 17 can indicate the exit direction from the guide point GP with high accuracy. Therefore, the driver who visually recognizes the route notification virtual image 17 can smoothly turn left or right at the guide point GP after recognizing the road to be exited.

In addition, the display control unit 53 of the present embodiment can adjust each value of the display start distance L1 to the exit distance L5 based on the road type information and the congestion information acquired as the traveling environment information. According to such adjustment, the display control unit 53 sequentially displays the intersection notification virtual image 13 and the lane notification virtual image 15 to the route notification virtual image 17 at the timing when the driver's driving action is required according to the actual road environment. As a result, the driver can perform a smooth driving operation based on the information presentation regardless of the traveling environment of the vehicle A.

Further, in the present embodiment, as described above, the accuracy of the map data acquired by the route guidance differs for each area depending on the content of the high accuracy map data and the presence or absence of the high accuracy map data. Therefore, the magnitude of the deviation that should be assumed for the superimposed virtual image 14 varies depending on the accuracy of the map data used for superimposing the superimposed virtual image 14.

In order to solve such a difficulty, in the present embodiment, the range used for displaying the superimposed virtual image 14 in the angle of view VA is changed according to the accuracy of the map data used for displaying the superimposed virtual image 14. Specifically, the display permission range UA is narrowed toward the lower edge of the angle of view VA as the accuracy of the map data becomes lower (insufficient). On the other hand, the range occupied by the display permission range UA in the angle of view VA is widened as the accuracy of the map data become higher. Then, in the high accuracy state where the accuracy of the map data is most ensured, the setting of the display permission range UA is omitted.

According to the above display control, even when the accuracy of the map data differs for each area, the magnitude of the deviation that may occur in the superimposed virtual image 14 is appropriately assumed, and the superimposed virtual image 14 that matches the accuracy of the map data used can be displayed. Therefore, depending on the accuracy of the map data, it is possible to display the guidance display object 11 that is easy to understand and is unlikely to be misidentified.

Note that, in the embodiment described above, the integrated display control block 73 corresponds to a “display generation unit”, while the projection range PA corresponds to a “displayable region”.

### Other Embodiments

Although one embodiment of the present disclosure has been described above, the present disclosure is not construed as being limited to the above-mentioned embodiments, and can be applied to various embodiments and combinations within a scope that does not depart from the spirit of the present disclosure.

The display of the non-superimposed virtual image in the above embodiment is terminated before the remaining distance became the switching distance. In this way, a display interruption period may be set while switching the guidance display object from the non-superimposed virtual image to the superimposed virtual image. Further, the display of the non-superimposed virtual image may be continued until the remaining distance reaches the switching distance, as in the case of guiding the destination. In such a modification, the guide display that guides the intersection is directly switched from the intersection notification virtual image to the lane notification virtual image.

The guide point guided by using the guide display is not limited to the above-mentioned intersection, branch, destination, or the like, and may be changed as appropriate. For example, as a guide point, a temporary stop registered in the navigation map data may be alerted. In this modification, a non-superimposed virtual image is displayed in either the pre-approach section or the approach section, notifying the presence of a pause. The non-superimposed virtual image is, for example, an image of a design imitating a stop road sign. Then, in the entry section where the pause position in the foreground is within the angle of view, a superimposed virtual image that emphasizes the pause position is displayed. The superimposed imaginary image is an image that is extended in a strip shape in the horizontal direction and is superimposed on, for example, a road surface that is a pause position. At this time, the display of the non-superimposed virtual image 12 imitating the road sign for the stop may be continued while not overlapping with the superimposed virtual image 14.

In the above embodiment, it is determined whether the map data is in the standard accuracy state or the low accuracy state depending on the presence or absence of the high accuracy map data. As a result, the range of the angle of view that can be used to display the superimposed virtual image is expanded or contracted based on the presence or absence of high accuracy map data. However, the criteria for determining the accuracy of map data can be changed as appropriate.

For example, the area limiting unit can determine the accuracy based on the scale of the navigation map data that can be used as an alternative. More specifically, the area limiting unit may determine that it is in the standard accuracy state when there is detailed navigation map data having a scale larger than a predetermined value even if there is no high accuracy map data. In other words, the area limiting unit may determine that it is in a low accuracy state when there is only navigation map data at a small scale equal to or less than the predetermined value. With this configuration, it is possible to realize information presentation that is easy to understand while allowing the accuracy difference for each area of available map data and suppressing the deviation.

When setting the display permission range, the change such as the size and position of the display permission range based on the route guidance information may be continuous or gradual. Furthermore, when the display permission range is set, the content whose display range is restricted within the display permission range may be limited to the content that can cause a situation that induces misunderstanding when the display deviation is conspicuous. That is, even if the display shift occurs, the content that is unlikely to cause misidentification may be displayed as a virtual image within the range within the angle of view excluding the display permission range.

Specifically, the content imitating a signboard such as a road sign, such as the deceleration sign virtual image 15c (see FIG. 6), may be displayed as a virtual image outside the display permission range. Further, a superimposed virtual image adjusted to have low attractiveness, such as the extended deceleration notification virtual image 16c (see FIG. 6), may be displayed outside the display permission range. The design of the signboard or the like displayed as a non-superimposed virtual image may also be changed periodically according to the information presented to the driver.

In the above embodiment, the virtual image display object displayed by the HUD device in the vicinity of the guide point is only the guidance display object. However, a virtual image display object other than the guidance display object may be displayed in the vicinity of the guide point. For example, in the pre-approach section, the superimposed virtual image that calls attention to a road sign, a pedestrian, or the like may be displayed together with the intersection notification virtual image. In addition, in the section closer to the guide intersection than the switching distance, the non-superimposed virtual image as an icon obtained by reducing the intersection notification virtual image may be supplementary displayed around the superimposed virtual image displayed as the guidance display object.

In the above embodiment, the superimposed virtual image is sequentially switched to the lane notification virtual image, the deceleration notification virtual image, the route notification virtual image, and the completion notification virtual image according to the remaining distance to the guide point. The number of such superimposed virtual images, the display duration of each superimposed virtual image, and the like may be changed as appropriate. Further, the information notified by each superimposed virtual image, the shape of each superimposed virtual image, and the like may be changed as appropriate. Further, the completion notification virtual image may be displayed as a non-superimposed virtual image instead of a superimposed virtual image. In addition, when it is estimated that the display object is overlooked by the driver, the non-superimposed virtual image and the superimposed virtual image may be redisplayed based on the driver's sensing information by DSM.

In the above embodiment, the display permission range in the approach section and the entry section is limited to a part of the projection range. The details of the control that limits the display range may be changed as appropriate. For example, the display permission range in the entry section may be larger than the display permission range in the approach section. Further, the display permission range may be continuously expanded as the remaining distance decreases. Further, the process of setting the display permission range may not be performed.

In addition, the initial shape and position of the display permission range, the expansion direction, and the like may be changed as appropriate. For example, the display permission range may be expanded laterally toward the exit direction as the guide point is approached. Further, the display permission range may be resized based on parameters different from the remaining distance and the recognition information.

In the above embodiment, detection that the vehicle leaves from the traveling route is set as one of the conditions for erasing the guidance display object (see FIG. 5 S110). As such an erasing condition, detection of a sign in which the vehicle leaves the traveling route may be set. In detail, when both high accuracy position information and high accuracy map data can be acquired, the display control device determines whether or not the traveling lane of the vehicle in front of the guidance point matches the recommended lane based on the route information. The display control device estimates that the vehicle will leave the traveling route when the traveling lane is different from the recommended lane. Based on the above estimation, the display control device terminates the display of the superimposed virtual image that may hinder the visibility of the foreground at an early stage.

The display control unit of the above embodiment changes each threshold distance based on the traveling environment information. The details of the change control of each threshold distance can be changed as appropriate. For example, among a plurality of threshold distances, a specific threshold distance (for example, a switching distance) may be excluded from the adjustment target based on the traveling environment information. In such a configuration, the display of the superimposed virtual image is disclosed at a fixed position where the remaining distance to the guide point is the switching distance. As a result, some drivers may find it easier to recognize the timing of the driving operation rather than adjusting the timing of the display transition. Further, the change control of each threshold distance does not have to be performed.

In the above embodiment, the non-superimposed virtual image is replaced with the superimposed virtual image based on the remaining distance. However, even after the superimposed virtual image is displayed, the display of the non-superimposed virtual image may be continued. Further, as a value corresponding to the remaining distance, the remaining time to the guide point may be used as a parameter for transitioning the display.

The input interface used by the occupant such as the driver to change the setting is not limited to the touch panel, the steering switch, and the like as in the above embodiment. For example, the setting of the display permission range, each threshold distance, and the like may be switched by inputting by at least one of voice and gesture as a user's operation. It should be noted that the setting change by the occupant does not have to be permitted.

The HUD device may be, for example, a bifocal projection device that forms a far virtual image and a near virtual image at different positions. In such a HUD device, the non-superimposed virtual image and the superimposed virtual image correspond to a display object displayed as a distant virtual image.

The optical configuration of the HUD device may be changed as appropriate. For example, the projector may be configured to include a laser light source and a MEMS scanner. For example, the projector may be a DLP (Digital Light Processing, registered trademark) projector using a DMD (Digital Micromirror Device). Further, a projector using LCOS (Liquid Crystal On Silicon) or the like, a liquid crystal projector having a liquid crystal panel and an LED light source, and the like my be adopted for the HUD device.

The display control device of the above embodiment is provided as an electronic control unit separate from the HUD device. Alternatively, each function of the display control device may be mounted in, for example, a control circuit provided in the HUD device, or may be mounted in a control circuit or the like provided in the combination meter.

In the above embodiments, each function provided by the control circuit of the display control device can be provided by software and hardware for executing the software, only software, only hardware, or a complex combination of the hardware and the software. Moreover, if the above functions are provided by an electronic circuit that is hardware, each function may also be provided by a digital circuit which includes multiple logic circuits, or an analog circuit.

Various non-transitory tangible storage media (non-transitory tangible storage medium) such as a flash memory and a hard disk can be employed as the memory device for storing the display control programs. The form of such a storage medium may be appropriately changed. For example, the storage medium may be in the form of a memory card or the like, inserted into a slot portion provided in the display control device, and electrically connected to the control circuit. Further, the storage medium is not limited to the memory device of the in-vehicle device as described above, and may be an optical disk serving as a copy base of the program to the memory device, a hard disk drive of a general-purpose computer, or the like.

The control portion and the method therefor which have been described in the present disclosure may be also realized by a dedicated computer which constitutes a processor programmed to execute one or more functions concretized by computer programs. Also, the device and the method therefor which have been described in the present disclosure may be also realized by a dedicated hardware logic circuit. Also, the device and the method therefor which have been described in the present disclosure may be also realized by one or more dedicated computers which are constituted by combinations of a processor for executing computer programs and one or more hardware logic circuits. The computer program may be stored, as instructions to be executed by a computer, in a tangible non-transitory computer-readable medium.

What is claimed is:

1. A display control device, for a vehicle, configured to control a display of a virtual image by a head-up display, the display control device comprising:
a processor configured to
generate a guidance display object that guides a traveling route for the vehicle;
recognize a remaining distance from the vehicle to a guide point at which a route guidance by the guidance display object is generated;
(i) display, as the guidance display object, a non-superimposed virtual image that does not identify a superimposition target when the remaining distance is longer than a switching distance, and (ii) display, as the guidance display object, a superimposed virtual image superimposed on a specific superimposition target when the remaining distance is shorter than the switching distance; and
define a display permission range that allows a display of the superimposed virtual image within an angle of view at which the virtual image is configured to be displayed according to an accuracy of map data used for recognizing the remaining distance.

2. The display control device according to claim 1, wherein
the processor enlarges the display permission range within the angle of view as the accuracy of the map data increases.

3. A display control device, for a vehicle, configured to control a display of a virtual image by a head-up display, the display control device comprising:
a processor configured to:
generate a guidance display object that guides a traveling route for the vehicle;
recognize a remaining distance from the vehicle to a guide point at which a route guidance by the guidance display object is generated; and
(i) first display, as the guidance display object, a non-superimposed virtual image that does not identify a superimposition target when the remaining distance is longer than a switching distance, and (ii) display, as the guidance display object, a superimposed virtual image superimposed on a specific superimposition target when the remaining distance is shorter than the switching distance, wherein
when high accuracy map data used for the route guidance at the guide point is available, the processor first displays, as the guidance display object, the superimposed virtual image even when the remaining distance is longer than the switching distance.

4. The display control device according to claim 3, wherein
when the high accuracy map data is not available, the processor displays, as the guidance display object, first the non-superimposed virtual image and then displays the superimposed virtual image, and
when high accuracy map data is available, the processor continuously displays, as the guidance display object, the superimposed virtual image from a beginning to an end.

5. A non-transitory tangible computer readable storage medium comprising instructions executed by at least one processor of a display control device, for a vehicle, configured to control a display of a virtual image by a head-up display, the instructions comprising:
generating a guidance display object that guides a traveling route for the vehicle;
recognizing a remaining distance from the vehicle to a guide point at which a route guidance by the guidance display object is generated;
displaying, as the guidance display object, a non-superimposed virtual image that does not identify a superimposition target when the remaining distance is longer than a switching distance;
displaying, as the guidance display object, a superimposed virtual image superimposed on a specific superimposition target when the remaining distance is shorter than the switching distance; and
defining a display permission range that allows a display of the superimposed virtual image within an angle of view at which the virtual image is configured to be displayed according to an accuracy of map data used for recognizing the remaining distance.

6. A non-transitory tangible computer readable storage medium comprising instructions executed by at least one processor of a display control device, for a vehicle, configured to control a display of a virtual image by a head-up display, the instructions comprising:
generating a guidance display object that guides a traveling route for the vehicle;
recognizing a remaining distance from the vehicle to a guide point at which a route guidance by the guidance display object is generated; and
first displaying, as the guidance display object, a non-superimposed virtual image that does not identify a superimposition target when the remaining distance is longer than a switching distance; and
displaying, as the guidance display object, a superimposed virtual image superimposed on a specific superimposition target when the remaining distance is shorter than the switching distance, wherein
when high accuracy map data used for the route guidance at the guide point is available, the displaying the superimposed virtual image includes first displaying, as the guidance display object, the superimposed virtual image even when the remaining distance is longer than the switching distance.
